(19) United States
(12) Patent Application Publication
(10) Pub. No.: US 2024/0037889 A1
(43) Pub. Date: Feb. 1, 2024

(54) IMAGE PROCESSING DEVICE, IMAGE PROCESSING METHOD, AND PROGRAM RECORDING MEDIUM

(71) Applicant: NEC Corporation, Minato-ku, Tokyo (JP)

(72) Inventors: Kenta SENZAKI, Tokyo (JP); Azusa SAWADA, Tokyo (JP); Hironobu MORI, Tokyo (JP); Kyoko MUROZONO, Tokyo (JP); Katsuya ODAKA, Tokyo (JP)

(73) Assignee: NEC Corporation, Minato-ku, Tokyo (JP)

(21) Appl. No.: 18/266,343

(22) PCT Filed: Nov. 26, 2021
(86) PCT No.: PCT/JP2021/043358

§ 371 Date: Jun. 9, 2023

(30) Foreign Application Priority Data
Dec. 21, 2020 (JP) 2020-210948

(51) Int. Cl. G06V 10/22; G06V 10/74; G06V 20/70; G06V 10/12; G06V 10/10

(52) U.S. Cl. CPC G06V 10/22; G06V 10/74; G06V 20/70; G06V 10/12; G06V 10/16

(57) ABSTRACT

This image processing device comprises an input unit, a verification area extraction unit, and an output unit. The input unit receives, as an annotation area, an input of information of an area on a first image in which an object subjected to annotation processing is present. The verification area extraction unit extracts a second image including the annotation area and captured in a manner different from that for the first image. The output unit outputs the first image and the second image in a comparable state.

### TECHNICAL FIELD

The present invention relates to an image processing device and the like.

### BACKGROUND ART

In order to effectively utilize satellite images and the like, various automatic analyses are performed. For development of an analysis method and performance evaluation in automatic analysis of an image, image data prepared with a correct answer is required. Accuracy of image data is also called annotation. In order to improve the accuracy of the automatic analysis, it is desirable to have image data in which many correct answers are prepared. However, it is often difficult to determine the contents of a satellite image, particularly image data generated by a synthetic aperture radar. Therefore, it is complicated and requires a lot of work to prepare the correct image data. In view of such a background, it is desirable to have a system that makes the work of correctly assigning image data efficient. As a technique for improving the efficiency of such an operation of assigning correct image data, for example, a technique such as PTL 1 is disclosed.

A transfer reading system of PTL 1 is a system that determines whether an object is lost by image processing. The transfer reading system of PTL 1 generates correct answer data indicating that there is no house in an image based on a comparison result between two pieces of image data captured at different times.

### CITATION LIST

### Patent Literature

PTL 1: JP 2020-30730 A

### SUMMARY OF INVENTION

### Technical Problem

However, the technique of PTL 1 is not sufficient in the following points. In PTL 1, the presence or absence of an object appearing in image data is determined based on two pieces of image data captured at different dates and times, and correct data is generated. However, in PTL 1, there is a possibility that accuracy of correct data is not sufficient in the case of an object whose target is difficult to determine.

In order to solve the above problems, an object of the present invention is to provide an image processing device and the like capable of improving accuracy while efficiently performing annotation processing.

### Solution to Problem

In order to solve the above problem, an image processing device of the present invention includes an input means that receives, as an annotation area, an input of information of an area on a first image in which an object to be subjected to annotation processing exists, a verification area extraction means that extracts a second image including the annotation area and captured by a method different from a method of the first image, and an output means that outputs the first image and the second image in a comparable state.

An image processing method of the present invention includes receiving, as an annotation area, an input of information of an area on a first image in which an object to be subjected to annotation processing exists, extracting a second image including the annotation area and captured by a method different from a method of the first image, and outputting the first image and the second image in a comparable state.

A program recording medium of the present invention records an image processing program stored therein for causing a computer to execute receiving, as an annotation area, an input of information of an area on a first image in which an object to be subjected to annotation processing exists, extracting a second image including the annotation area and captured by a method different from a method of the first image, and outputting the first image and the second image in a comparable state.

### Advantageous Effects of Invention

According to the present invention, it is possible to improve accuracy while efficiently performing annotation processing.

### BRIEF DESCRIPTION OF DRAWINGS

FIG. 1 is a diagram illustrating an outline of a configuration of a first example embodiment of the present invention.

FIG. 2 is a diagram illustrating an example of a configuration of an image processing device according to the first example embodiment of the present invention.

FIG. 3 is a diagram illustrating an example of an operation flow of the image processing device according to the first example embodiment of the present invention.

FIG. 4 is a diagram illustrating an example of an operation flow of the image processing device according to the first example embodiment of the present invention.

FIG. 5 is a diagram illustrating an example of a target image according to the first example embodiment of the present invention.

FIG. 6 is a diagram illustrating an example of a candidate area on a target image according to the first example embodiment of the present invention.

FIG. 7 is a diagram illustrating an example of an operation of setting a candidate area of a target image according to the first example embodiment of the present invention.

FIG. 8 is a diagram illustrating an example of an operation of setting a candidate area of a target image according to the first example embodiment of the present invention.

FIG. 9 is a diagram illustrating an example of a reference image according to the first example embodiment of the present invention.

FIG. 10 is a diagram illustrating an example of a candidate area on a target image according to the first example embodiment of the present invention.

FIG. 11 is a diagram illustrating an example of a display screen according to the first example embodiment of the present invention.

FIG. 12 is a diagram illustrating an example of the display screen according to the first example embodiment of the present invention.

FIG. 13 is a diagram illustrating an example of the display screen according to the first example embodiment of the present invention.

FIG. 14 is a diagram illustrating an example of the display screen according to the first example embodiment of the present invention.

FIG. 15 is a diagram illustrating an example of the display screen according to the first example embodiment of the present invention.

FIG. 16 is a diagram illustrating an example of the display screen according to the first example embodiment of the present invention.

FIG. 17 is a diagram illustrating another example of the operation flow of the image processing device according to the first example embodiment of the present invention.

FIG. 18 is a diagram illustrating an outline of a configuration of a second example embodiment of the present invention.

FIG. 19 is a diagram illustrating an example of a configuration of an image processing device according to the second example embodiment of the present invention.

FIG. 20 is a diagram illustrating an example of an operation flow of the image processing device according to the second example embodiment of the present invention.

FIG. 21 is a diagram illustrating an outline of a configuration of a third example embodiment of the present invention.

FIG. 22 is a diagram illustrating an example of an operation flow of the image processing device according to the third example embodiment of the present invention.

FIG. 23 is a diagram illustrating another configuration example of the example embodiment of the present invention.

### EXAMPLE EMBODIMENT

### First Example Embodiment

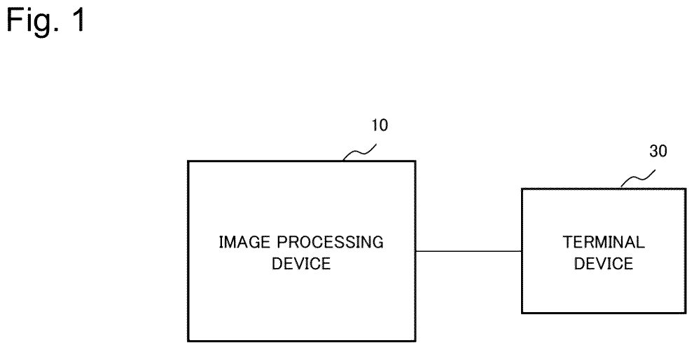

A first example embodiment of the present invention will be described in detail with reference to the drawings. FIG. 1 is a diagram illustrating an outline of a configuration of an image processing system of the present example embodiment. The image processing system of the present example embodiment includes an image processing device 10 and a terminal device 30. The image processing system according to the present example embodiment is a system which performs annotation processing on an image acquired using, for example, a synthetic aperture radar (SAR).

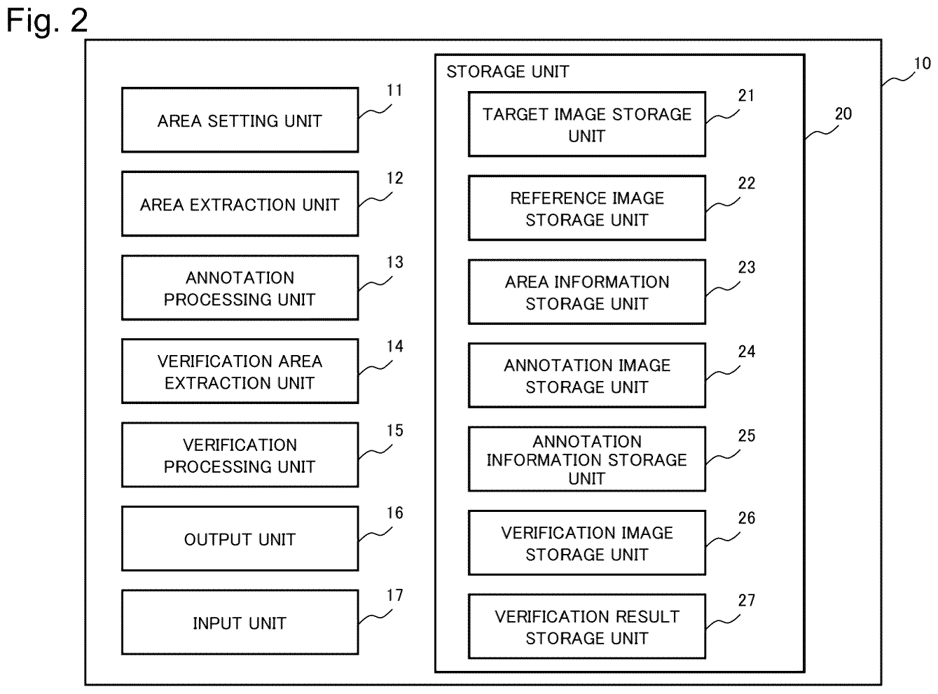

A configuration of the image processing device 10 will be described. FIG. 2 is a diagram illustrating an example of a configuration of the image processing device 10. The image processing device 10 includes an area setting unit 11, an area extraction unit 12, an annotation processing unit 13, a verification area extraction unit 14, a verification processing unit 15, an output unit 16, an input unit 17, and a storage unit 20.

The storage unit 20 includes a target image storage unit 21, a reference image storage unit 22, an area information storage unit 23, an annotation image storage unit 24, an annotation information storage unit 25, a verification image storage unit 26, and a verification result storage unit 27.

The area setting unit 11 sets, as a candidate area, an area in which there is a possibility that an object (hereinafter, referred to as a target object) to be an annotation target exists in the target image and the reference image. The target image is an image to be subjected to annotation processing. The reference image is an image used as a comparison target when it is determined whether the target object exists in the target image by comparing the two images at the time of performing the annotation processing. The reference image is an image acquired when an area including an area of the target image is different from the target image. The number of reference images relevant to one target image may be plural.

The area setting unit 11 sets, as a candidate area, an area where there is a possibility that a target object exists in the target image. The area setting unit 11 stores the range of the candidate area on the target image in the area information storage unit 23. The area setting unit 11 stores the range of the candidate area on the target image in the area information storage unit 23 using, for example, coordinates in the target image.

For example, the area setting unit 11 specifies an area in which the state of the reflected wave is different from that of the surroundings, that is, an area in which the luminance is different from that of the surroundings in the target image, and sets the area as the candidate area. The area setting unit 11 specifies all portions where there is a possibility that a target object exists in one target image and sets the specified portions as candidate areas. The area setting unit 11 may compare the position where the target image is acquired with the map information, and set a candidate area in a preset area. For example, when the target object is a ship, the area setting unit 11 may set a candidate area in an area where there is a possibility that the ship exists, such as the sea, rivers, and lakes and marshes, with reference to the map information. By limiting the setting range of the candidate area with reference to the map information, the annotation processing can be made efficient.

The area extraction unit 12 extracts an image of the candidate area set on the target image and an image on the reference image relevant to the same position as the candidate area. The area extraction unit 12 sets an image in the candidate area of the target image as a candidate image G1. The area extraction unit 12 extracts an image of an area whose position is relevant to the candidate area from the reference image including the candidate area of the target image. For example, the area extraction unit 12 extracts an image of an area relevant to a candidate area from two reference images including the candidate area of the target image. For example, the area extraction unit 12 extracts a relevant image G2 from a reference image A acquired one day before the day on which the target image is acquired by the synthetic aperture radar, and extracts a relevant image G3 from a reference image B acquired two days before. The number of reference images may be one or three or more.

The annotation processing unit 13 generates data for displaying the annotation information input by an operator's operation. The annotation information is information for specifying an area where an object exists in the candidate image. For example, the annotation processing unit 13 generates data for displaying the annotation information as a rectangular diagram enclosing an object on the candidate image. The area indicated by the annotation information is also referred to as an annotation area. The annotation processing unit 13 generates data for displaying information relevant to the rectangular information displayed on the candidate image on the relevant image. The annotation processing unit 13 stores the annotation information in the annotation information storage unit 25 in association with the candidate image and the reference image.

The verification area extraction unit 14 extracts a verification image having a position relevant to the annotation area from a verification image. The verification image is an image used for verifying whether the annotation processing is correctly performed and classifying the target object. As the verification image, an image in which an object being captured is more easily identified than the target image is used. The verification image is, for example, an optical image captured by a camera that captured an area of visible light.

Based on the comparison between the candidate image and the verification image, the verification processing unit 15 receives a comparison result input by an operator's operation as verification information via the input unit 17. When the verification information indicates that the annotation area is correctly set and the classification of the target object is correct, the verification processing unit 15 stores the annotation information in association with the candidate image in the annotation image storage unit 24 as the annotation image.

The output unit 16 generates display data for displaying a candidate image relevant to the same candidate area and a relevant image in a comparable manner. The output unit 16 generates display data for displaying the candidate image and the verification image relevant to the same area in a comparable manner. The display data to be displayed in a comparable manner refers to, for example, display data in a state in which an operator can compare two images by arranging the two images in the horizontal direction. The output unit 16 outputs the generated display data to the terminal device 30. The output unit 16 may output the display data to a display device connected to the image processing device 10.

The input unit 17 acquires an input result by an operator's operation from the terminal device 30. The input unit 17 acquires the information on the setting of the annotation area as an input result. The input unit 17 acquires, as input results, information indicating whether the annotation area input to the terminal device 30 as the comparison result between the candidate image and the verification image is correct and information on the classification of the object. The input unit 17 may acquire an input result from an input device connected to the image processing device 10.

Each processing in the area setting unit 11, the area extraction unit 12, the annotation processing unit 13, the verification area extraction unit 14, the verification processing unit 15, the output unit 16, and the input unit 17 is performed, for example, by executing a computer program on a central processing unit (CPU).

The target image storage unit 21 of the storage unit 20 stores the image data of the target image. The reference image storage unit 22 stores the image data of the reference image. The area information storage unit 23 stores information on the range of the candidate area set by the area setting unit 11. The annotation image storage unit 24 stores the image data subjected to the annotation processing as an annotation image. The annotation information storage unit 25 stores the information of the annotation area. The verification image storage unit 26 stores the image data of the verification image. The verification result storage unit 27 stores the information on the verification result of the annotation processing. The image data of the target image, the reference image, and the verification image is stored in advance in the storage unit 20 by the operator. The image data of the target image, the reference image, and the verification image may be acquired via a network and stored in the storage unit 20.

The storage unit 20 is configured by, for example, a non-volatile semiconductor storage device. The storage unit 20 may be configured by another storage device such as a hard disk drive. The storage unit 20 may be configured by combining a non-volatile semiconductor storage device and a plurality of types of storage devices such as a hard disk drive. Part or all of the storage unit 20 may be provided in a device outside the image processing device 10.

The terminal device 30 is a terminal device for operation by an operator, and includes an input device and a display device (not illustrated). The terminal device 30 is connected to the image processing device 10 via a network.

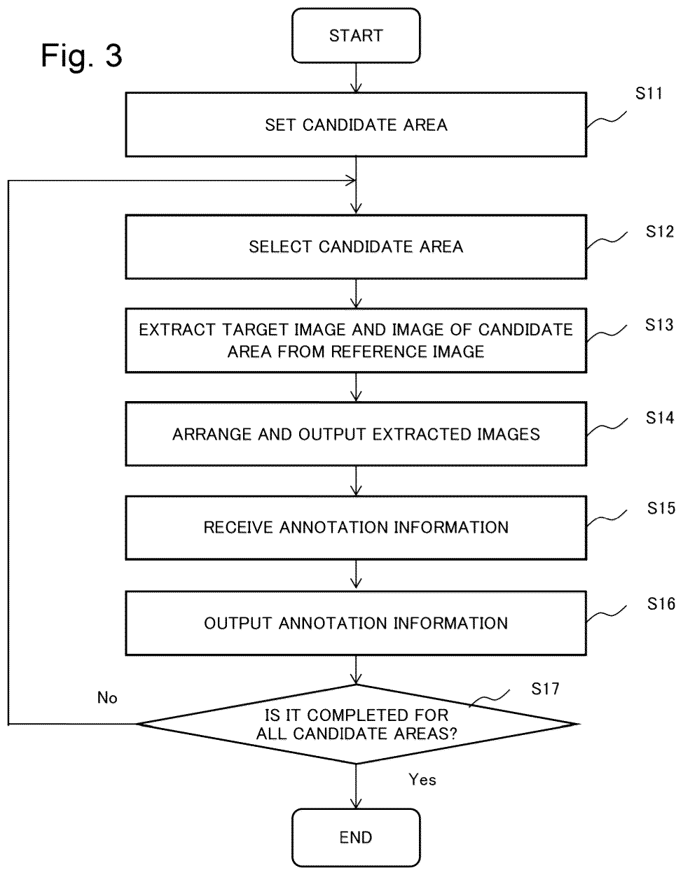

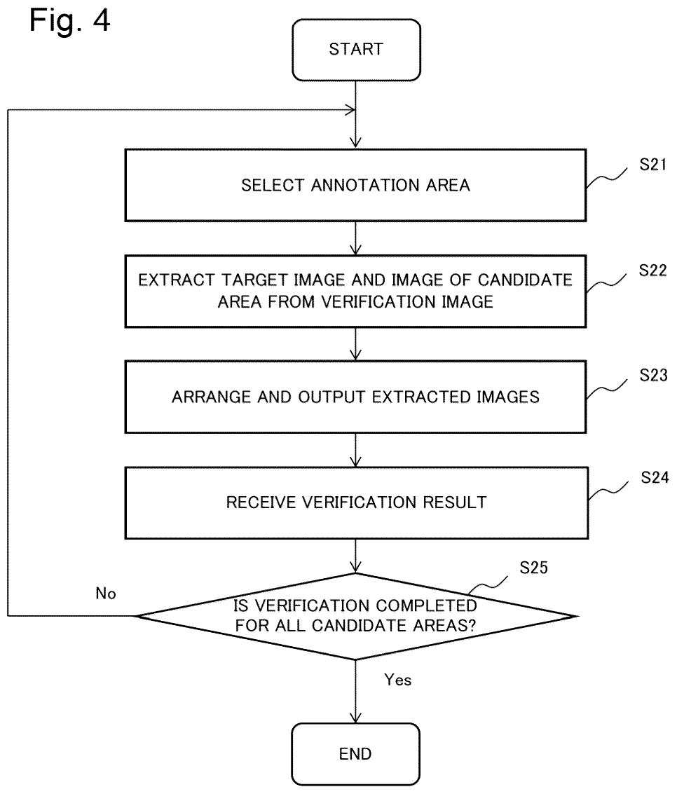

An operation of the image processing system of the present example embodiment will be described. FIGS. 3 and 4 are diagrams illustrating an example of an operation flow of the image processing device 10 according to the present example embodiment.

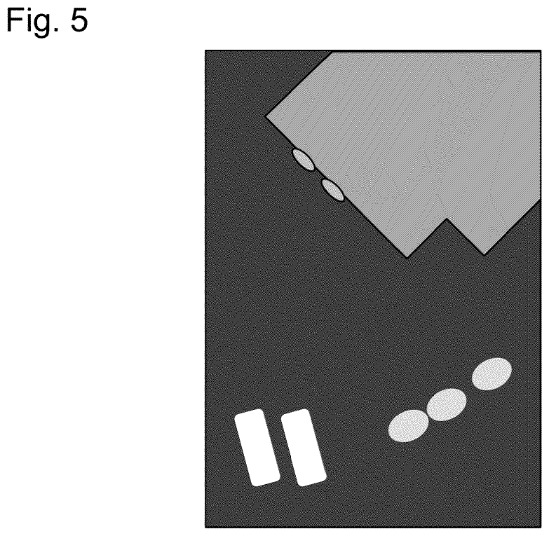

The area setting unit 11 of the image processing device 10 reads the target image to be subjected to the annotation processing from the target image storage unit 21 of the storage unit 20. FIG. 5 is a diagram illustrating an example of a target image. FIG. 5 is image data captured by the synthetic aperture radar. The elliptical and rectangular areas in FIG. 5 indicate areas where the reflected wave is different from the surroundings, that is, areas where there may be an object.

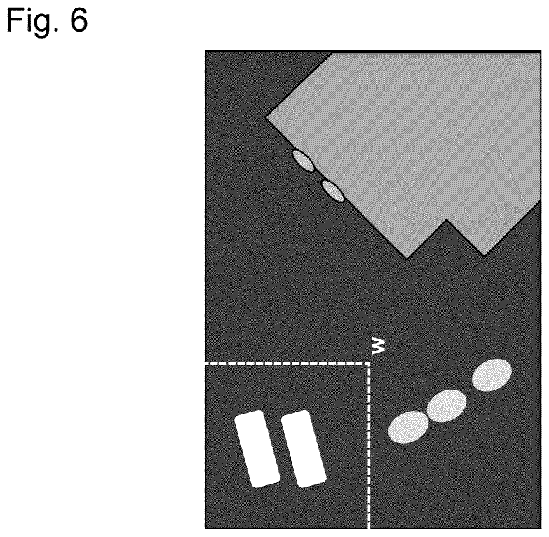

In FIG. 3, the area setting unit 11 sets an area that may include a target object of the annotation as a candidate area on the target image (step S11). For example, the area setting unit 11 specifies an area where there is a possibility that an object exists based on a luminance value of an image, and sets a candidate area. The area setting unit 11 sets an area smaller than the entire target image as a candidate area. FIG. 6 illustrates an example of a candidate area W set on the target image. In FIG. 6, the candidate area W is set to an area surrounded by a dotted line from the lower left corner of the target image.

When the candidate area is set, the area setting unit 11 stores information of the set candidate area in the area information storage unit 23. The area setting unit 11 stores, for example, coordinates of the set candidate area in the area information storage unit 23 as information of the candidate area.

The area setting unit 11 sets a plurality of candidate areas W so as to cover the entire area of the candidate area existing in the target image. The area setting unit 11 stores the coordinates of each candidate area W on the target image in the area information storage unit 23.

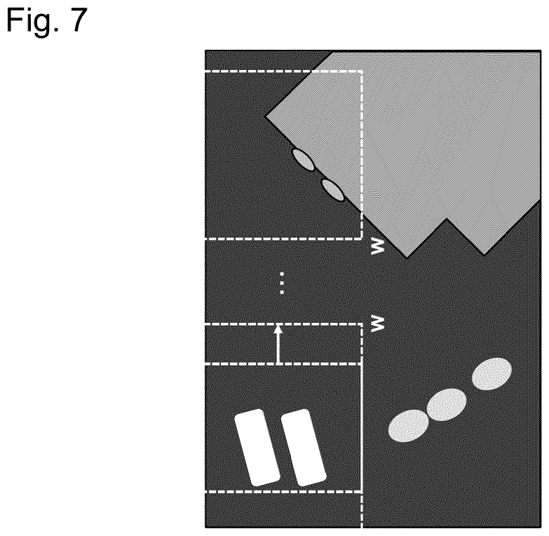

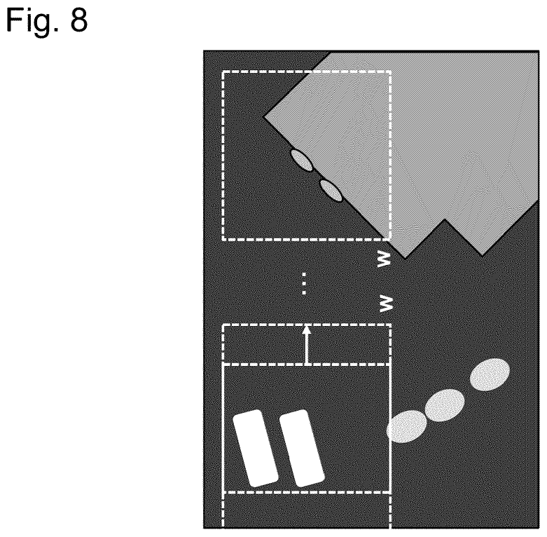

FIGS. 7 and 8 are diagrams illustrating an example of an operation of setting a plurality of candidate areas W. For example, as illustrated in FIG. 7, the area setting unit 11 sequentially slides the candidate area W set in the lower left corner area of the target image in the vertical direction of the drawing, and sets a plurality of other candidate areas W. As illustrated in FIG. 8, the area setting unit 11 further sets a plurality of candidate areas W by sliding the candidate areas W in the horizontal direction of the drawing and then sequentially sliding the candidate areas W in the vertical direction of the drawing. At this time, the candidate areas W may or may not overlap each other.

When the candidate area is set, the area extraction unit 12 extracts an image relevant to the candidate area W from the target image and the reference image. The area extraction unit 12 selects one candidate area W from a plurality of set candidate areas W (step S12). When the candidate area W is selected, the area extraction unit 12 reads coordinates of the selected candidate area on the target image from the area information storage unit 23. After reading the coordinates, the area extraction unit 12 extracts an image on the target image relevant to the specified position of the candidate area W as the candidate image G1 from the read coordinates. The area extraction unit 12 extracts an image on the reference image relevant to the position in the candidate area W as a relevant image (step S13). For example, the area extraction unit 12 extracts an image located in the candidate area W from the two reference images as the relevant image G2 and the relevant image G3.

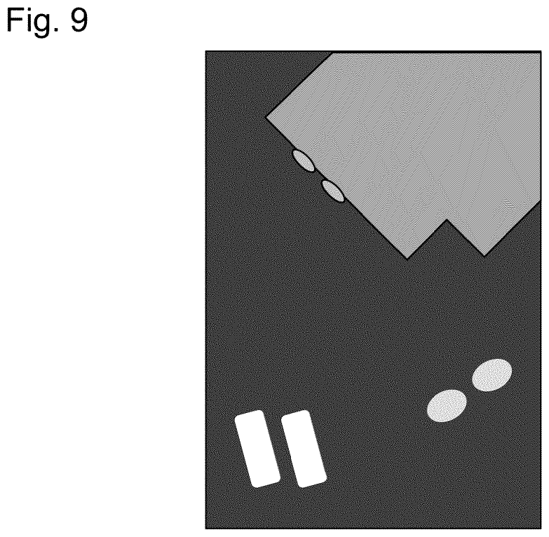

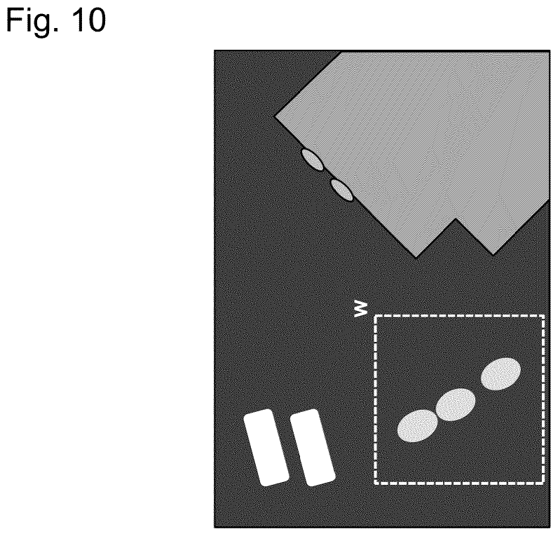

FIG. 9 is a diagram illustrating an example of a reference image. FIG. 9 illustrates an example in which the number of elliptical areas is different from that of the target image in FIG. 5 since the target image is an image acquired at a time different from that of the target image. FIG. 10 is a diagram illustrating an example of the candidate area W selected in step S13. For example, when the candidate area W is selected as illustrated in FIG. 10, the area extraction unit 12 extracts an image on the target image in the same area as the selected candidate area W as the candidate image G1, and extracts an image in the same area as the candidate area W among the areas of the reference image in FIG. 9 as the relevant image G2. In a case where there is still another reference image, the area extraction unit 12 extracts the relevant image G3.

After extracting the candidate image G1, the relevant image G2, and the relevant image G3, the output unit 16 generates display data in which the candidate image G1, the relevant image G2, and the relevant image G3 relevant to one candidate area are arranged in a comparable manner, and outputs the display data to the terminal device 30 (step S14). When receiving the display data, the terminal device 30 displays the display data in which the candidate image G1, the relevant image G2, and the relevant image G3 are arranged in a comparable manner on a display device (not illustrated).

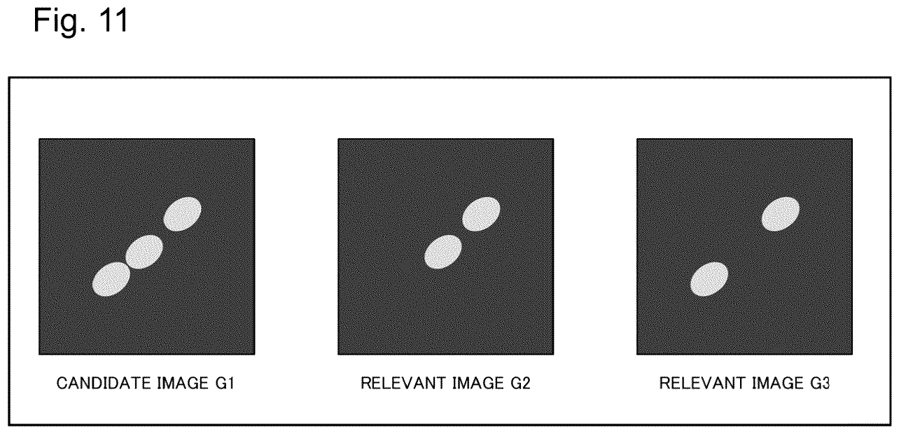

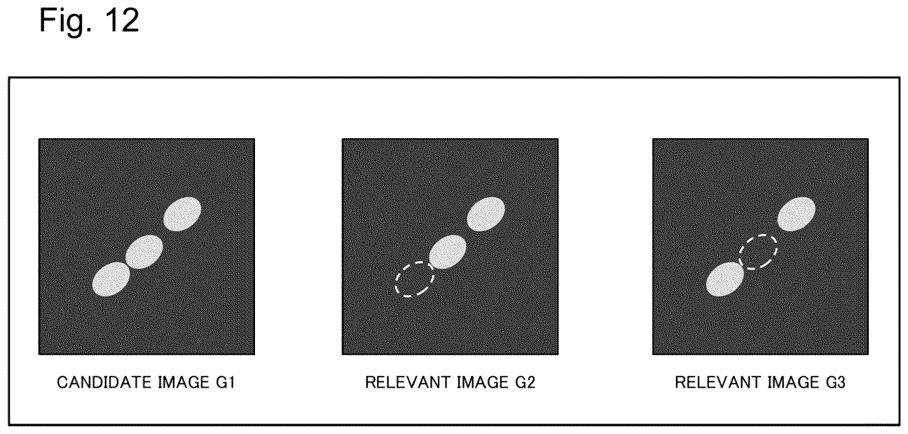

FIG. 11 is a diagram illustrating an example of a display screen on which the candidate image G1, the relevant image G2, and the relevant image G3 are displayed in a comparable manner. For example, as illustrated in FIG. 11, the output unit 16 displays the candidate image G1, the two relevant images G2, and the relevant image G3 side by side on one screen. FIG. 12 illustrates, in the image of FIG. 11, an area in which an object exists in the candidate image G1 but is considered not to be present in the relevant image G2 and the relevant image G by a dotted line. By displaying the candidate image G1, the relevant image G2, and the relevant image G3 in a comparable manner as described above, the operator can recognize the area where the object exists.

The output unit 16 may display the candidate image G1 and one relevant image G2, and then output display data for displaying the candidate image G1 and the relevant image G3. The output unit 16 may output display data for alternately displaying the candidate image and the relevant image. After displaying the candidate image, the output unit 16 may output display data for sequentially displaying a plurality of relevant images in a slide show format, or may output display data for sequentially changing and displaying the relevant images to different images when repeatedly and alternately displaying the candidate image and the relevant image.

When the screen as illustrated in FIG. 11 is displayed on the terminal device 30, the area where the target object exists on a candidate image G11 is set as the annotation area by an operator's operation. When the information of the annotation area input by an operator's operation is input to the terminal device 30, the terminal device 30 transmits the information of the annotation area to the image processing device 10 as annotation information.

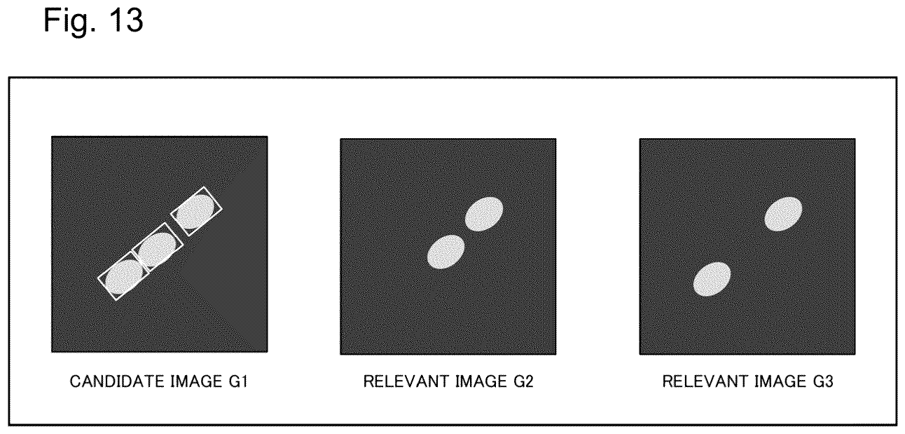

FIG. 13 illustrates an example in which the annotation area is set on the candidate image G1 by an operator's operation. In FIG. 13, an area surrounded by a rectangular line on the candidate image G1 is set as the annotation area.

The input unit 17 of the image processing device 10 receives the annotation information from the terminal device 30. When the annotation information is received via the input unit 17, the annotation processing unit 13 generates data in which the information on the annotation area input from the operator is added onto the candidate image G1, the relevant image G2, and the relevant image G3, and sends the data to the output unit 16. When receiving the data of the candidate image G1, the relevant image G2, and the relevant image G3 to which the information of the annotation area has been added, the output unit 16 generates display data for displaying the annotation area on the candidate image G1, the relevant image G2, and the relevant image G3. After generating the display data, the output unit 16 outputs the generated display data to the terminal device 30 (step S16). When receiving the display data, the terminal device 30 displays the received display data on the display device.

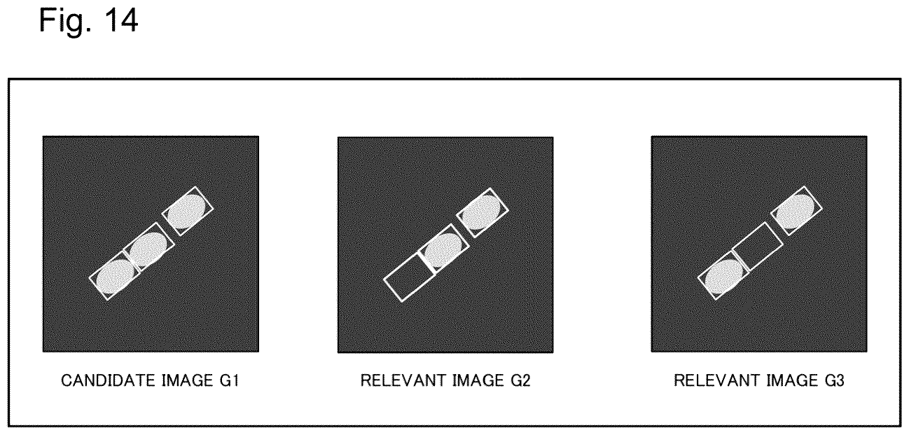

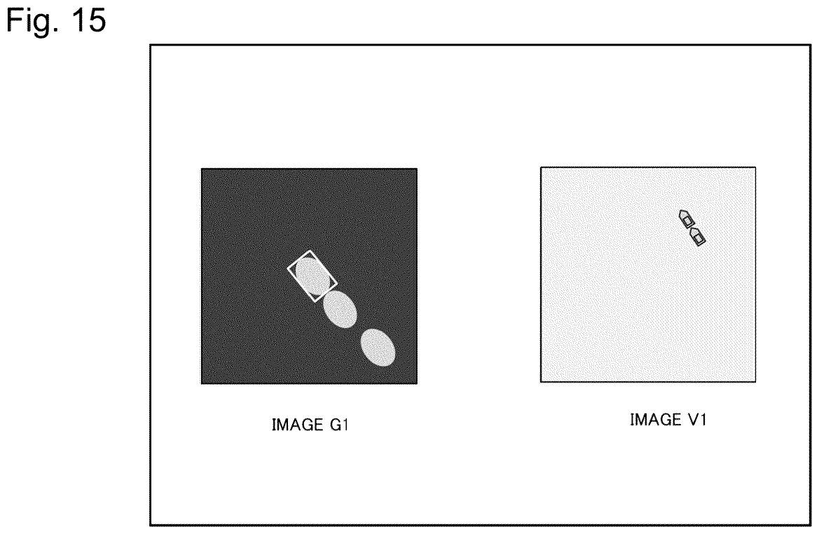

FIG. 14 illustrates an example of a display screen in which the annotation area is displayed on the candidate image G1, the relevant image G2, and the relevant image G3. As illustrated in FIG. 15, the output unit 16 displays information indicating the annotation area at positions on the relevant image G2 and the relevant image G3 relevant to the annotation area set on the candidate image G1. For example, as illustrated in FIG. 14, the output unit 16 generates display data for displaying the annotation area as a rectangular diagram enclosing the object existing on the candidate image G1, the relevant image G2, and the relevant image G3.

When the display data indicating the annotation area is output, the annotation processing unit 13 stores the annotation information in the annotation information storage unit 25. The annotation information is information in which information on the annotation area is associated with the candidate image G1. In a case where the setting of the annotation area has been completed for all the candidate areas when the annotation information is saved (Yes in step S17), the image processing device 10 ends the setting processing of the annotation area and starts the verification processing. When there is a candidate area for which setting of the annotation area has not been completed (No in step S17), the image processing device 10 repeatedly executes processing from the operation of selecting the candidate area in step S12.

When the verification processing is started, the verification area extraction unit 14 reads the annotation information about the image being processed from the annotation information storage unit 25. In FIG. 4, the verification area extraction unit 14 selects any one piece of annotation information from pieces of annotation information for which verification processing has not been performed (step S21).

After reading the annotation information, the verification area extraction unit 14 reads the corresponding target image from the target image storage unit 21. When the target image is read, the verification area extraction unit 14 extracts an area relevant to the annotation area on the target image as the image G1. The verification area extraction unit 14 reads the relevant verification image from the verification image storage unit 26. The verification image read at this time may be an image obtained by captured an area wider than the target image as long as the verification image includes the annotation area indicated by the annotation information. As long as the verification image includes the annotation area, a part of the capturing range may deviate from the target image. After reading the verification image, the verification area extraction unit 14 extracts an area relevant to the annotation area on the verification image as an image V1 (step S22). The image V1 may be of an area wider than the image G1 as long as the image V1 includes the area of the image G1.

When the image V1 relevant to the annotation area is extracted from the verification image, the output unit 16 generates display data for displaying the image G1 and the image V1 side by side in a comparable manner. After generating the display data, the output unit 16 outputs the generated display data to the terminal device 30 (step S23). When receiving the display data, the terminal device 30 displays the image G1 and the image V1 side by side on the display device in a comparable manner.

FIG. 15 illustrates an example of a display screen on which the image G1 and the image V1 are displayed side by side in a comparable manner. The left side of FIG. 15 illustrates an example of the image G1 by the synthetic aperture radar on which the annotation processing has been performed, and the right side illustrates an example of the image V1 by the optical image. The display screen of FIG. 15 illustrates a case where the image V1 is read in a wider range than the image G1.

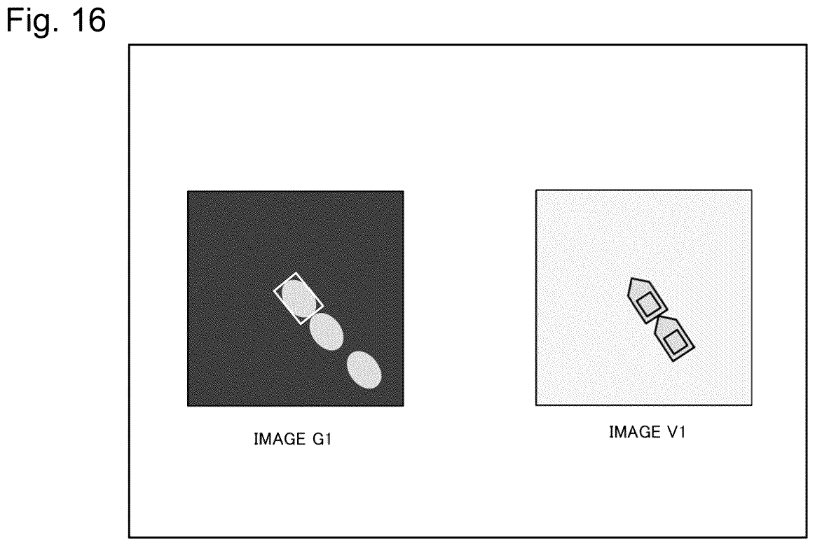

The output unit 16 may change the display data based on the input result by an operator's operation. The output unit 16 may output display data for displaying the verification image by switching the verification image to an image such as a grayscale image, a true color image, a false color image, or an infrared image according to an operator's operation. The grayscale image is also referred to as a punctual image. The output unit 16 may perform adjustment, enlargement processing, or reduction processing of the display position of the image V1 according to an operator's operation. FIG. 16 illustrates an example of display data for enlarging and displaying the image V1. When the center position of the image V1 is designated according to an operator's operation, the output unit 16 may generate the display data by enlarging or reducing the ground resolution (also referred to as pixel spacing) per pixel of the image V1 in accordance with the image V1.

The verification processing unit 15 receives verification information that is information input by an operator's operation on the display of the image G1 and the image V1 (step S24). When the image data for detecting a ship is generated, the verification information is input as information indicating whether the setting of the annotation area is correct and information indicating whether the ship exists in the annotation area displayed in the image G1. In the case of generating image data for specifying the classification, the verification information is input as information indicating whether the setting of the annotation area is correct and information of the classification of the object specified by looking at the image V1. The verification processing unit 15 stores the input verification information in the verification result storage unit 27 as verification result information.

The verification result information is, for example, information indicating whether the object existing in the annotation area is a detection target or a non-detection target. The verification result information may include type information set in advance. The type information can be, for example, information in which any of items such as a ship, a buoy, an aquaculture raft, a container, a driftwood, or an unknown item is selected. In a case where there is no item relevant to the predetermined type information, an item added to the choices by the operator may be received.

When the verification result information is saved, the verification processing unit 15 associates the annotation information including the classification information of the object with the image G1 and generates the annotation information as an annotation image. The verification processing unit 15 stores the annotation image in the annotation image storage unit 24. The annotation image generated in this way can be used as, for example, training data of machine learning.

In a case where the verification for all the candidate areas has been completed when the information on the verification result has been saved (Yes in step S25), the image processing device 10 completes the verification processing. When there is a candidate area for which verification is not completed (No in step S25), the image processing device 10 returns to step S21, selects a new annotation area, and repeats the verification processing.

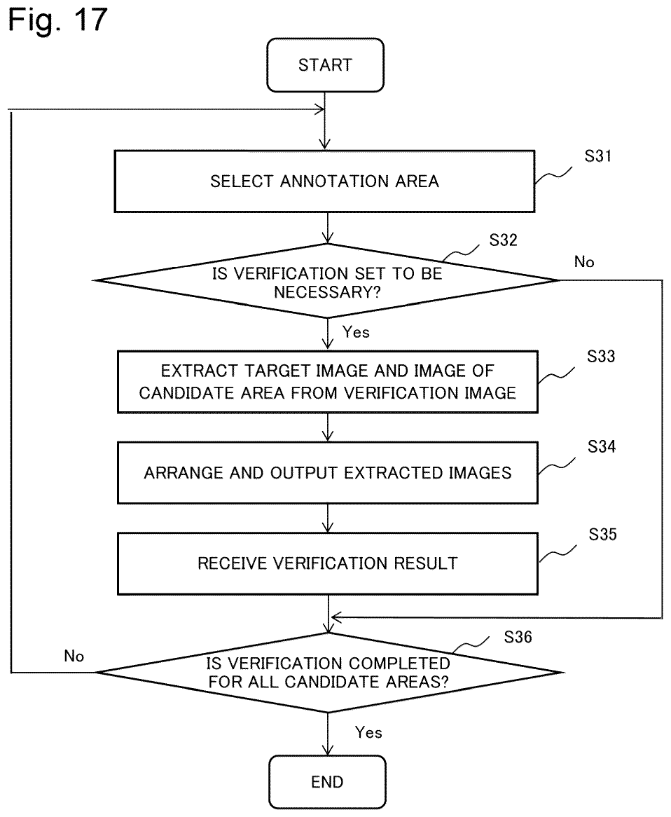

In the above example, the verification processing is performed for all the annotation areas, but the necessity of verification may be selected. FIG. 17 is a diagram illustrating an operation flow in a case where necessity is confirmed at the time of performing the verification processing.

When the verification processing is started, the verification area extraction unit 14 reads the annotation information about the image being processed from the annotation information storage unit 25. In FIG. 17, the verification area extraction unit 14 selects any one piece of annotation information from pieces of annotation information for which verification processing has not been performed (step S31).

When the annotation information is extracted, the verification area extraction unit 14 reads the corresponding target image from the target image storage unit 21. When the target image is read, the output unit 16 outputs the image in which the annotation area is displayed and the display data for confirming necessity of verification to the terminal device 30.

The terminal device 30 displays the image on which the annotation area is displayed and a display screen for confirming necessity of verification on the display device. When the information on the necessity of verification is input by an operator's operation, the terminal device 30 transmits the information on the necessity of verification to the image processing device 10.

When verification is necessary (Yes in step S32), the verification area extraction unit 14 reads the relevant verification image from the verification image storage unit 26. After reading the verification image, the verification area extraction unit 14 extracts an area relevant to the annotation area on the verification image as the image V1 (step S33).

When the image V1 relevant to the annotation area is read from the verification image, the output unit 16 generates display data for displaying the image G1 and the image V1 side by side in a comparable manner. After generating the display data, the output unit 16 outputs the generated display data to the terminal device 30 (step S34). When receiving the display data, the terminal device 30 displays the image G1 and the image V1 side by side on the display device in a comparable manner.

The verification processing unit 15 receives verification result information that is information input by an operator's operation on the display of the image G1 and the verification image V1 (step S35).

When receiving the information of the verification result, the verification processing unit 15 associates the annotation information including the information of the classification of the object with the image G1 and generates the annotation information as an annotation image. The verification processing unit 15 stores the annotation image in the annotation image storage unit 24.

In a case where the verification for all the candidate areas has been completed when the annotation image has been saved (Yes in step S36), the image processing device 10 completes the verification processing. When there is a candidate area for which verification is not completed (No in step S36), the image processing device 10 returns to step S21, selects a new annotation area, and repeats the verification processing.

When the verification processing is unnecessary in step S32 (No in step S32), in a case where the verification for all the candidate areas has been completed (Yes in step S36), the image processing device 10 completes the verification processing. When there is a candidate area for which verification is not completed (No in step S36), the image processing device 10 returns to step S21, selects a new annotation area, and repeats the verification processing.

The above description has been made for the example in which the annotation processing is performed on the target image acquired by the synthetic aperture radar, but the target image may be an image acquired by a method other than the synthetic aperture radar. For example, the target image may be an image acquired by an infrared camera.

The image processing device 10 of the image processing system according to the present example embodiment displays an image obtained by extracting an area where there is a possibility that an object exists from the target image to be subjected to annotation processing and an image obtained by extracting a relevant area from the reference image in a comparable manner. Therefore, it is possible to efficiently set the annotation area by performing work using the image processing device 10 of the present example embodiment. The image processing device 10 displays, in a comparable manner, the image of the set annotation area and the annotation area extracted from the image acquired by a method different from the target image. Therefore, the object existing in the annotation area can be easily identified by performing the work using the image processing device 10 of the present example embodiment. As a result, the image processing system of the present example embodiment can improve accuracy while efficiently performing annotation processing.

### Second Example Embodiment

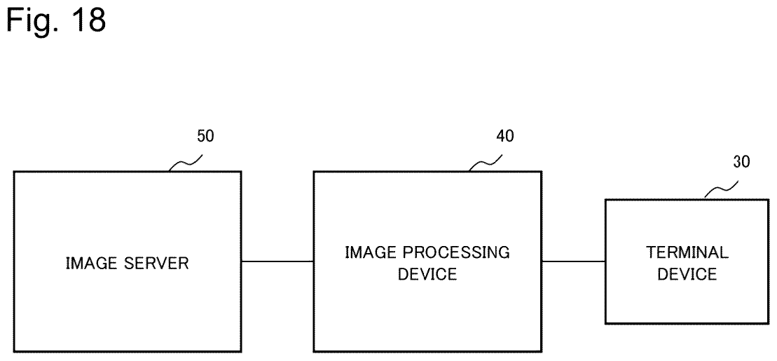

A second example embodiment of the present invention will be described. FIG. 18 is a diagram illustrating an outline of a configuration of an image processing system of the present example embodiment. The image processing system of the present example embodiment includes an image processing device 40, a terminal device 30, and an image server 50. In the image processing system of the first example embodiment, the verification image has been input to the image processing device by the operator. The image processing device 40 according to the present example embodiment acquires the verification image from the image server 50 via the network.

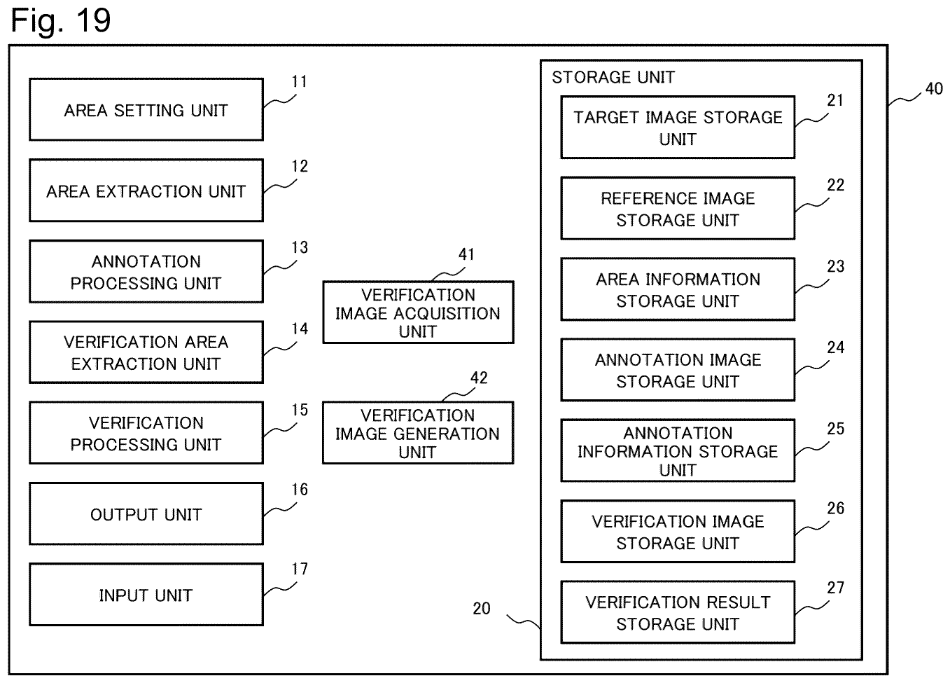

A configuration of the image processing device 40 will be described. FIG. 19 is a diagram illustrating an example of a configuration of the image processing device 40. The image processing device 40 includes an area setting unit 11, an area extraction unit 12, an annotation processing unit 13, a verification area extraction unit 14, a verification processing unit 15, an output unit 16, an input unit 17, a storage unit 20, a verification image acquisition unit 41, and a verification image generation unit 42. The configurations and functions of the area setting unit 11, the area extraction unit 12, the annotation processing unit 13, the verification area extraction unit 14, the verification processing unit 15, the output unit 16, and the input unit 17 of the image processing device 40 are similar to the parts having the same names in the first example embodiment.

The verification image acquisition unit 41 acquires the verification image from the image server 50. The verification image acquisition unit 41 stores the acquired verification image in the verification image storage unit 26 of the storage unit 20.

The verification image generation unit 42 generates a verification image used for the verification processing based on the verification image acquired from the image server 50. A verification image generation method will be described later.

The storage unit 20 includes a target image storage unit 21, a reference image storage unit 22, an area information storage unit 23, an annotation image storage unit 24, an annotation information storage unit a verification image storage unit 26, and a verification result storage unit 27. The configuration and function of each part of the storage unit are similar to those of the first example embodiment.

The configuration and function of the terminal device 30 are similar to those of the terminal device 30 of the first example embodiment.

The image server 50 stores data of optical images obtained by capturing each point. The image server 50 adds data including a capturing position, a capturing date and time, and a cloud amount to image data of an optical image obtained by capturing each point and stores the data. The image processing device 40 is connected to the image server 50 via a network. The image processing device 40 acquires, for example, image data from an image server provided by the European Space Agency as a verification image candidate. The image processing device 40 may acquire verification image candidates from a plurality of image servers 50.

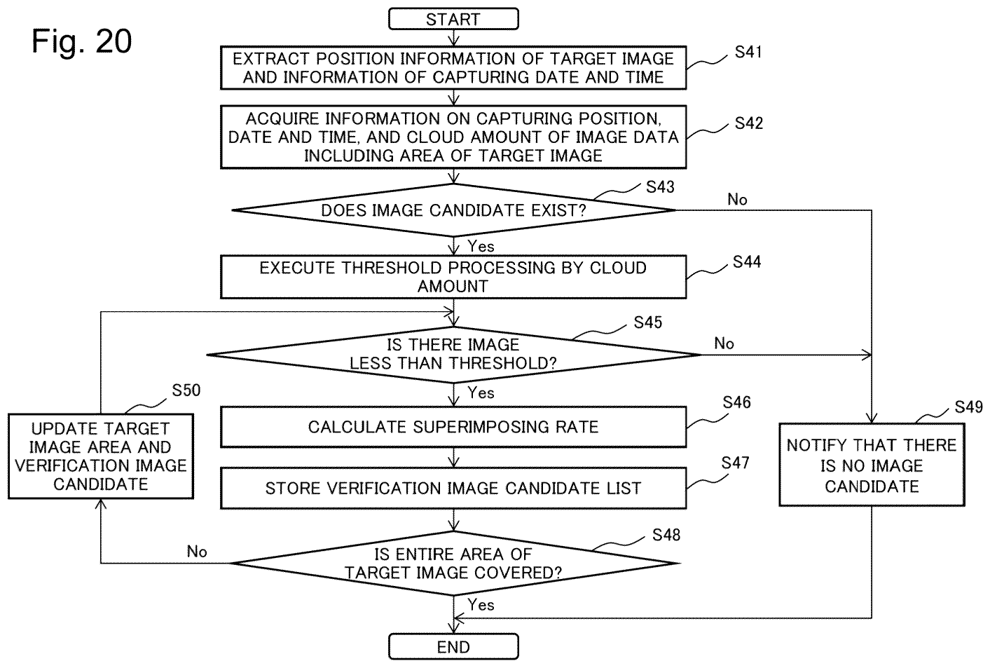

An operation of the image processing system of the present example embodiment will be described. The operations of the annotation processing and the verification processing are similar to those of the first example embodiment. Therefore, only the operation of generating the verification image will be described below. FIG. 20 is a diagram illustrating an operation flow of the image processing device 40 when generating a verification image.

The verification image generation unit 42 extracts information on the capturing position and the capturing date and time of the target image of the annotation processing (step S41). After extracting the information on the capturing position and the capturing date and time of the target image, the verification image generation unit 42 acquires information on the capturing position, the capturing date and time, and the cloud amount of the image data including the position relevant to the capturing position of the target image as the capturing position from the image server 50 via the verification image acquisition unit 41 (step S42).

When there is no target image data (No in step S43), the verification image generation unit 42 outputs information indicating that there is no image candidate of the verification image to the terminal device 30 via the output unit 16 (step S49). When the information indicating that there is no image candidate of the verification image is output, the verification image generation unit 42 ends the processing for the target image being generated. When there is no image candidate of the verification image, the verification image data is acquired by the operator, or the image being processed is excluded from the target of the annotation processing.

When the information on the capturing position, the capturing date and time, and the cloud amount can be acquired in step S42 and the verification image candidate exists (Yes in step S43), the verification image generation unit 42 generates a verification image candidate list based on the acquired data. The verification image candidate list is data in which an identifier of a target image, a capturing position of the target image, an identifier of a verification image candidate, and information added to the verification image candidate are associated.

When the verification image candidate list is generated, the verification image generation unit 42 executes processing of comparing the cloud amount with a threshold set in advance (step S44). When the cloud amount is equal to or more than the threshold set in advance, the verification image generation unit 42 determines that the cloud amount is not suitable for the verification image and excludes the cloud amount from the verification image candidate list.

When there is an image whose cloud amount is less than the threshold (Yes in step S45), the verification image generation unit 42 calculates an area superimposing rate of the target image with respect to the verification image candidate using the position information of the verification image candidate and the position information of the target image (step S46).

When there are a plurality of verification image candidates, an area superimposing rate for each verification image candidate is calculated. After calculating the area superimposing rate, the verification image generation unit 42 divides the verification image candidates into groups set in a plurality of stages based on the magnitude of the area superimposing rate. After the grouping, the verification image generation unit 42 determines, as the verification image, a verification image having the latest capturing date and time among the groups having the largest area superimposing rate. The verification image generation unit 42 may determine the latest image among the verification image candidates of which the area superimposing rate is equal to or greater than a reference set in advance as the verification image. The verification image generation unit 42 may score each of the area superimposing rate and the capturing date and time by using preset criteria, and determine a verification image candidate having the largest sum or product of the scores as the verification image. When the verification image is determined, the verification image generation unit 42 stores the information indicating that the candidate image is determined as the verification image by writing the information in the verification image candidate list (step S47).

When the determination as the verification image is written in the verification image candidate list, the verification image generation unit 42 confirms the area of the target image that can be covered by the stored verification image. When the entire area of the target image has been covered (Yes in step S48), the verification image generation unit 42 erases data of an image that has not been determined as the verification image from the verification image candidate list for the target image being processed, and completes the processing of generating the verification image.

In step S48, in a case where the entire area of the target image has not been covered (No in step S48), the verification image generation unit 42 updates the information of the target area and the verification image candidate for the area that has not been covered (step S50). After updating the information on the target area and the verification image candidate, the process returns to step S45, and the verification image generation unit 42 repeats the processing from the determination of the presence or absence of an image less than the threshold of the cloud amount. At this time, the verification image generation unit 42 may delete, from the verification image candidate list, information on verification image candidates having an area superimposing rate lower than a preset reference.

When there is no image whose cloud amount is less than the threshold when the threshold processing based on the cloud amount is performed in step S44 (No in step S45), the verification image generation unit 42 outputs information indicating that there is no image candidate of the verification image to the terminal device 30 via the output unit 16 (step S49). When the information indicating that there is no verification image candidate is output, the verification image generation unit 42 ends the processing for the target image being generated.

When the entire area of the target image is covered in step S48, the verification image acquisition unit 41 acquires the image data of the verification image candidate list from the image server 50. When the image data is acquired, the verification image acquisition unit 41 stores the acquired image data in the verification image storage unit 26.

When the image data relevant to the verification image candidate list is acquired, the verification image generation unit 42 synthesizes the image data with one image and stores the image data in the verification image storage unit 26 as a verification image. When synthesizing the verification image, the verification image generation unit 42 preferentially synthesizes an image having a high area superimposing rate. For example, when a plurality of images overlap each other at the same position, the verification image generation unit 42 performs synthesis using image data having the highest area superimposing rate. When there is only one piece of image data relevant to the verification image candidate list, the verification image generation unit 42 does not synthesize images.

When a verification image is generated for a target area of one target image, processing of generating a verification image of another target image is performed. When the generation processing of the verification images for all the target images is completed, the generation processing of the verification images is completed.

When the generation processing of the verification image is completed, the setting of the annotation area and the verification processing are performed similarly to the first example embodiment, and data subjected to the annotation processing is generated. The data subjected to the annotation processing is used as training data in machine learning, for example.

The image processing device 40 of the image processing system according to the present example embodiment acquires the verification image candidate used for generating the verification image from the image server 50 via the network. Therefore, in the image processing system of the present example embodiment, it is not necessary for the operator to collect the verification image, and thus the work can be made efficient.

### Third Example Embodiment

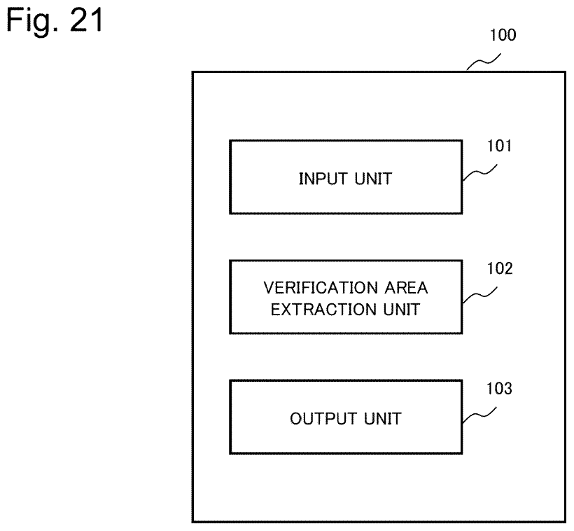

A third example embodiment of the present invention will be described in detail with reference to the drawings. FIG. 21 is a diagram illustrating an outline of a configuration of an image processing device 100. The image processing device 100 of the present example embodiment is provided with an input unit 101, a verification area extraction unit 102, and an output unit 103. The input unit 101 receives, as an annotation area, an input of information of an area on a first image in which an object subjected to annotation processing exists. The verification area extraction unit 102 extracts a second image including the annotation area and captured in a manner different from that for the first image. The output unit 103 outputs the first image and the second image in a comparable state.

The input unit 17 and the annotation processing unit 13 are examples of the input unit 101. The input unit 101 is an aspect of an input means. The verification area extraction unit 14 is an example of the verification area extraction unit 102. The verification area extraction unit 102 is an aspect of a verification area extraction means. The output unit 16 is an example of the output unit 103. The output unit 103 is an aspect of an output means.

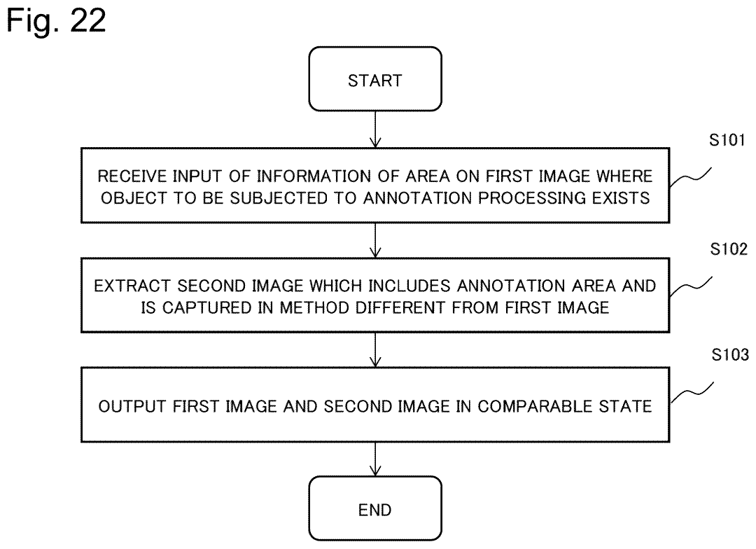

The operation of the image processing device 100 will be described. FIG. 22 is a diagram illustrating an example of an operation flow of the image processing device 100. The input unit 101 receives, as an annotation area, an input of information of an area on a first image in which an object subjected to annotation processing exists (step S101). When the annotation area is received, the verification area extraction unit 102 extracts a second image including the annotation area and captured by a method different from that of the first image (step S102). When the second image is extracted, the output unit 103 outputs the first image and the second image in a comparable state (step S103).

The image processing device 100 according to the present example embodiment extracts the second image including the annotation area and captured by a method different from that of the first image, and outputs the first image and the second image in a comparable state. The image processing device 100 according to the present example embodiment can improve the efficiency of the annotation processing work by outputting the first image and the second image relevant to the annotation area in a comparable state. In the image processing device 100 of the present example embodiment, the first image and the second image are output in a comparable state, so that it is easy to specify the object existing in the annotation area. As a result, it is possible to improve the accuracy while efficiently performing the annotation processing by using the image processing device 100 of the present example embodiment.

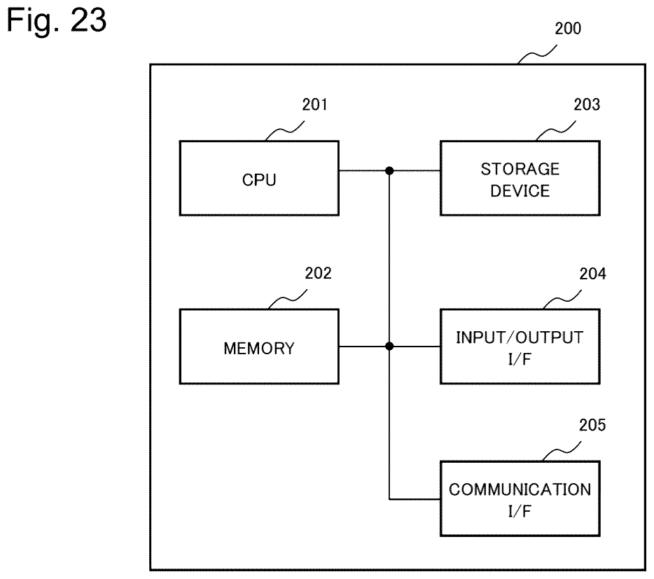

Each processing in the image processing device 10 of the first example embodiment, the image processing device 40 of the second example embodiment, and the image processing device 100 of the third example embodiment can be performed by executing a computer program on a computer. FIG. 23 illustrates an example of a configuration of a computer 200 that executes a computer program for performing each processing in the image processing device 10 of the first example embodiment, the image processing device 40 of the second example embodiment, and the image processing device 100 of the third example embodiment. The computer 200 includes a CPU 201, a memory 202, a storage device 203, and an input/output interface (I/F) 204, and a communication I/F 205.

The CPU 201 reads and executes the computer program for performing each processing from the storage device 203. The CPU 201 may be configured by a combination of a CPU and a graphics processing unit (GPU). The memory 202 includes a dynamic random access memory (DRAM) or the like, and temporarily stores a computer program executed by the CPU 201 and data being processed. The storage device 203 stores a computer program executed by the CPU 201. The storage device 203 includes, for example, a non-volatile semiconductor storage device. As the storage device 203, another storage device such as a hard disk drive may be used. The input/output I/F 204 is an interface that receives an input from an operator and outputs display data and the like. The communication I/F 205 is an interface that transmits and receives data to and from each device constituting the monitoring system. The terminal device 30 and the image server 50 can have similar configurations.

The computer program used for executing each processing can be stored in a recording medium and distributed. As the recording medium, for example, a magnetic tape for data recording or a magnetic disk such as a hard disk can be used. As the recording medium, an optical disk such as a compact disc read only memory (CD-ROM) can also be used. A non-volatile semiconductor storage device may be used as a recording medium.

The present invention has been described above using the above-described example embodiments as examples. However, the present invention is not limited to the above-described example embodiments. That is, the present invention can apply various aspects that can be understood by those of ordinary skill in the art without departing from the spirit and scope of the present invention.

This application is based upon and claims the benefit of priority from Japanese patent application No. 2020-210948, filed on Dec. 21, 2020, the disclosure of which is incorporated herein in its entirety by reference.

### REFERENCE SIGNS LIST

10 image processing device
11 area setting unit
12 area extraction unit
13 annotation processing unit
14 verification area extraction unit
15 verification processing unit
16 output unit
17 input unit
20 storage unit
21 target image storage unit
22 reference image storage unit
23 area information storage unit
24 annotation image storage unit
25 annotation information storage unit
26 verification image storage unit
27 verification result storage unit
30 terminal device
40 image processing device
41 verification image acquisition unit
42 verification image generation unit
100 image processing device
101 input unit
102 verification area extraction unit
103 output unit
200 computer
201 CPU
202 memory
203 storage device
204 input/output I/F
205 communication I/F

What is claimed is:

1. An image processing device comprising:
at least one memory storing instructions; and
at least one processor configured to access the at least one memory and execute the instructions to:
receive, as an annotation area, information of an area on a first image in which an object to be subjected to annotation processing exists;
extract a second image including the annotation area and captured by a method different from a method of the first image; and
output the first image and the second image in a comparable state.

2. The image processing device according to claim 1, wherein
the at least one processor is further configured to execute the instructions to:
set, as a candidate area, an area where there is a possibility that an object to be subjected to the annotation processing exists in the first image; and
extract an image of an area relevant to the candidate area from a third image captured when the third image is different from the first image;
output an image of the candidate area of the first image and an image of an area relevant to the candidate area of the third image in a comparable state.

3. The image processing device according to claim 2, wherein
the at least one processor is further configured to execute the instructions to:
set a plurality of candidate areas by sliding an area on the first image.

4. The image processing device according to claim 2, wherein
the at least one processor is further configured to execute the instructions to:
acquire a plurality of pieces of image data including an area relevant to the annotation area; and
generate the third image relevant to the first image including the annotation area by combining the plurality of pieces of image data.

5. The image processing device according to claim 1, wherein
the at least one processor is further configured to execute the instructions to:
an input as to whether to perform comparison with the second image for each of the first images;
extract the second image when information indicating that comparison with the second image is to be performed is input; and
output the first image and the second image in a comparable state.

6. An image processing method comprising:
receiving, as an annotation area, information of an area on a first image in which an object to be subjected to annotation processing exists;
extracting a second image including the annotation area and captured by a method different from a method of the first image; and
outputting the first image and the second image in a comparable state.

7. The image processing method according to claim 6, further comprising:
setting, as a candidate area, an area where there is a possibility that an object to be subjected to the annotation processing exists in the first image;
extracting an image of an area relevant to the candidate area from a third image captured when the third image is different from the first image; and
outputting an image of the candidate area of the first image and an image of an area relevant to the candidate area of the third image in a comparable state.

8. The image processing method according to claim 7, further comprising:
acquiring a plurality of pieces of image data including an area relevant to the annotation area; and
generating the third image relevant to the first image including the annotation area by combining the plurality of pieces of image data.

9. The image processing method according to claim 6, further comprising:
receiving an input as to whether to perform comparison with the second image for each of the first images;
extracting the second image when information indicating that comparison with the second image is to be performed is input; and
outputting the first image and the second image in a comparable state.

10. A non-transitory program recording medium recording an image processing program for causing a computer to execute:
receiving, as an annotation area, information of an area on a first image in which an object to be subjected to annotation processing exists;
extracting a second image including the annotation area and photographed by a method different from a method of the first image; and
outputting the first image and the second image in a comparable state.

11. The image processing device according to claim 2, wherein
the object is a ship,
the first image is an image captured by a synthetic aperture radar,
the second image includes an optical image of the ship, and
the at least one processor is further configured to execute the instructions to:
set the candidate area by specifying an area in which a state of reflected wave is different from surroundings in within an area where there is a possibility that the ship in the first image.
